(19) United States
(12) Patent Application Publication
(10) Pub. No.: US 2011/0004590 A1
(43) Pub. Date: Jan. 6, 2011

(54) ENABLING MANAGEMENT OF WORKFLOW

(75) Inventors: Steven E. Lilley, Leesburg, VA (US); Phanindra Mankale, Centreville, VA (US)

Correspondence Address: BIRCH STEWART KOLASCH & BIRCH, PO BOX 747, FALLS CHURCH, VA, 22040-0747, US

(73) Assignee: LILLEY VENTURES, INC. DBA WORKPRODUCTS, INC., Leesburg, VA (US)

(21) Appl. No.: 12/715,142

(22) Filed: Mar. 1, 2010

Related U.S. Application Data
(60) Provisional application No. 61/156,668, filed on Mar. 2, 2009.

(51) Int. Cl. G06F 17/30

(52) U.S. Cl. 707/723; 707/769; 707/E17.014

(57) ABSTRACT

Systems, methods, and computer-readable mediums provide for dynamically generating a user interface based on components or user interfaces utilized in past and/or current matters. Alternatively, systems, methods, and computer-readable mediums provide for generating recommendations regarding a new matter based on information stored regarding past and/or current matters. Alternatively, systems, methods, and computer-readable mediums provide for generating a recommendation regarding how to proceed in a new matter based on cost in a past and/or current matter.

### RELATED APPLICATIONS

This application claims priority to U.S. Provisional Patent Application No. 61/156,668 entitled “SYSTEMS AND METHODS FOR MANAGING THE LIFECYCLE OF EVIDENCE FOR CORPORATE LITIGATION AND/OR INVESTIGATION” filed on Mar. 2, 2009, the entire contents of which are expressly incorporated herein by reference in its entirety.

### BACKGROUND

Today, many organizations have Enterprise Records Management (ERM) systems that provide clear guidelines for data retention and destruction. In addition, organizations facing frequent lawsuits often use Electronic Data Discovery (EDD) vendors and outside counsel to process and review evidence during discovery. Unfortunately, neither solution creates a framework that recognizes all data as potential evidence and puts a consistent methodology in place for handling it through attorney-client communications in an efficient, auditable, and cost effective manner.

### SUMMARY

Systems, methods, apparatus and computer-readable mediums, consistent with the principles of some embodiments of the present disclosure provide for dynamically generating a user interface, including receiving information identifying at least one of a current matter type, issue, a potential damage award, a potential total cost, other matter-related information, and information identifying a person; generating a query including the received information; accessing a database including actual past and/or current matters, each of the actual past and/or current matters having associated therewith at least related matter information and a user interface including a plurality of components; performing the generated query on the accessed database; receiving a result of the performed query including at least one past and/or current matter from the performed generated query and a plurality of components of a user interface associated with each received past matter; selecting at least one component of the user interface associated with the identified past and/or current matter in the result; and dynamically generating a user interface including the selected at least one component.

Alternatively, systems, methods, apparatus and computer-readable mediums, consistent with the principles of some embodiments of the present disclosure provide for maintaining information for generating a recommendation, including storing attribute information associated with at least one past and/or current matter; for each stored matter, storing a plurality of phases, each phase having at least one step, each step having at least one task, wherein each phase, step and task have information associated therewith; receiving attribute information regarding a current matter; generating a query based on the received attribute information; accessing the at least one past and/or current matter and the associated attribute information and performing the query on the accessed at least one past and/or current matter; receiving a result of the performed query, the result including at least one past and/or current matter and information associated therewith; analyzing the received result; and generating a recommendation based on the analysis of the received result.

Alternatively, systems, methods, apparatus and computer-readable mediums, consistent with the principles of some embodiments of the present disclosure provide for determining a cost for providing a recommendation, including initiating crawling at least one mass storage device; receiving information associated with the crawled data; estimating cost of analyzing collected information based on actual costs incurred in similar past and/or current matters; comparing estimated cost of analyzing data with a predetermined threshold of cost to be spent on analyzing data; and recommending proceeding with the matter if the compared cost does not exceed the predetermined threshold.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings. In the drawings:

FIG. 1 depicts an example system environment consistent with the principles of some embodiments of the present disclosure;

FIG. 2 depicts and example architecture for matterspace application consistent with the principles of some embodiments of the present disclosure;

FIG. 3 depicts an example screen shot of a dashboard consistent with the principles of some embodiments of the present disclosure;

FIG. 4. depicts an example flow diagram of the steps performed by server 102 in dynamically creating a workflow and dashboard consistent with the principles of some embodiments of the present disclosure;

FIG. 5 depicts an example diagram of ELM Analytics in the cloud architecture, consistent with the principles of some embodiments of the present disclosure;

FIG. 6 depicts an example diagram of ELM Analytics on the premises architecture, consistent with the principles of some embodiments of the present disclosure;

FIG. 7 depicts an example flow diagram of a method for analyzing scope and cost consistent with the principles of some embodiments of the present disclosure; and

FIG. 8 depicts an example flow diagram of a method for generating a recommendation consistent with the principles of some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

### Introduction

Features consistent with some principles of the disclosure generally relate to a systems and method for automating and managing the lifecycle of evidence for corporate litigation and/or investigations, and more specifically through marrying legal matter-specific attorney-client communication and information with forensically sound file level identification, preservation, collection, and delivery of evidence from enterprise resident and non-resident file sources. It may be appreciated that although the present disclosure is discussed within the context of corporate litigation and/or investigations, features consistent with the principles of the present disclosure may be applied to other matters and applications.

### Overall System Flow

The following describes a process for implementing a matter within a computing system environment. A corporation may begin an internal investigation, or may be served with a notice of litigation. A new matter may be created within matterspace application. Members and specific user rights and permissions are set for each identified Coordinator, Participant (Data Custodian), and Observer. Specific preservation email notifications are sent to identified Participants (Custodians) chosen from the Member Directory. All email/IM communications are stored for audit and reporting purposes.

Members are provided access to their permissioned items, including calendar events, tasks, List of Collections, file source location folders, etc.

Enterprise data map is generated to include each Participant's (Custodian's) accessible data sources, such as email, file shares, SharePoint, document repositories, email archives, etc.

Participants (Custodians) identify file locations for personal data sources, including home computer, USB drives, Web-based email, etc.

Matterspace crawls all identified data sources for each custodian, including indexing, file-level de-duplication (using, for example, MD5 Hash technology), forensically-sound collection, and source/custodian statistics reporting, and stores a single instance all relevant native files to the Work Space preservation folder, creating a file-level “Golden Copy.”

Permissioned users conduct advance searches, including keyword, search clusters by year/author/type, concept/issue analysis, etc., for search relevancy ranking and key document concepts.

Relevant native file search results containing a thorough chain-of-custody report are viewed in HTML and tagged for potential production. Non-relevant files are culled and eliminated.

Parsed index text, metadata, and the associated native files are exported to standard review platforms for use by internal/external counsel in developing the case or investigation materials.

Reviewers search and review the data, and to determine whether certain data should be audited, reported on, produced, and delivered as evidence.

Throughout this process, activity and event logs for each matter item and event may be evaluated by permissioned Coordinators and Observers to ensure matter consistency and thoroughness. Comprehensive audit reporting is available as needed for internal auditors, court proceedings, and/or regulators.

In addition to the above, other matters, for example, past and/or current matters, may be searched and accessed in order to obtain and utilize information for the new matter. This information may be trends, forms, interrogatories, costs, workflows and/or components thereof, dashboards, etc.

### System Environment

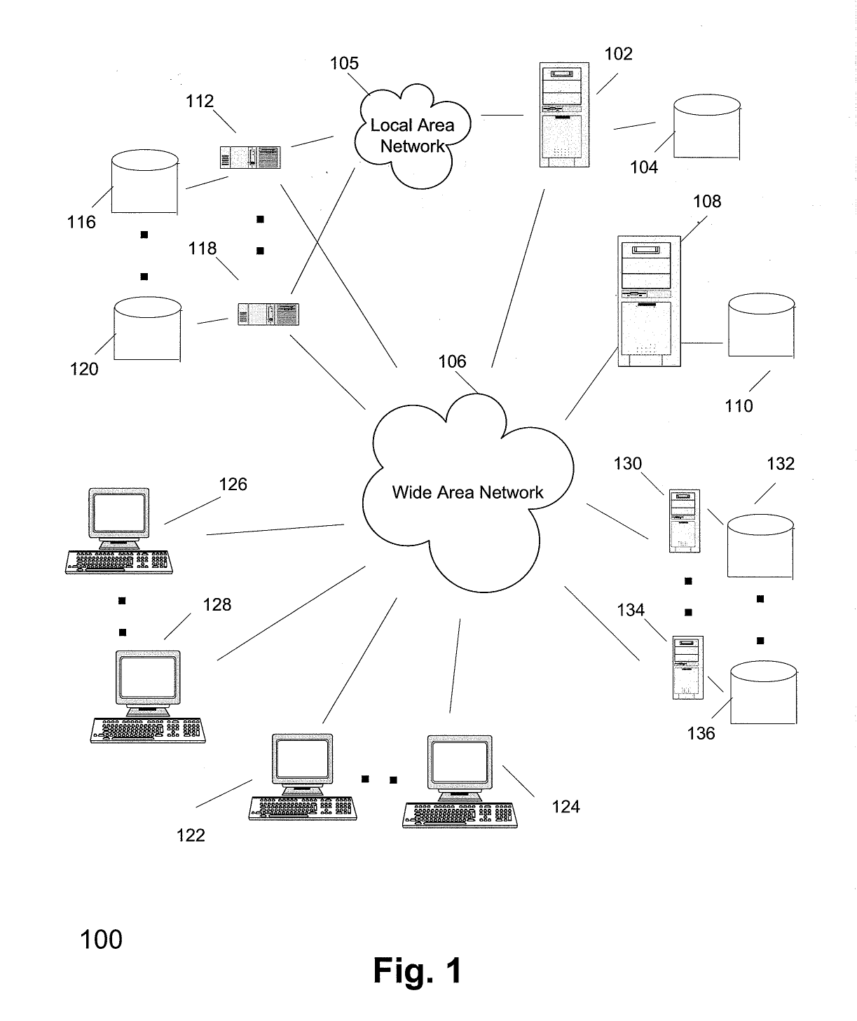

FIG. 1 is an exemplary diagram of a system environment 100 for implementing the principles consistent with some embodiments of the present disclosure. The components of system environment 100 can be implemented through any suitable combinations of hardware, software, and/or firmware. It may be appreciated that while only a limited number of devices are depicted in FIG. 1, additional devices may reside within system environment 100 and perform functionality similar to that which is discussed herein.

As shown in FIG. 1, system 100 includes server 102, which may be implemented within a corporate legal department. Server 102 may be communicably linked, either directly or indirectly to storage device 104. Storage device 104 may include information related to one or more matters, for example, name of matter, issue(s) associated with the matter, workflow of the matter, names and/or roles of persons performing steps and tasks in the workflow of the matter, costs of the matter, awards of the matter, documents and/or forms used in the matter, interrogatories, etc. Server 102 may be communicably linked to computing devices 112, 118 through a local area network 105.

Computing devices 112, 118 may be implemented within the corporate environment and operated by corporate employees. Computing devices 112, 118 may be communicably linked, either directly or indirectly, to storage devices 116, 120, respectively. Storage devices 116, 120 may include structured or unstructured enterprise stored data.

System 100 may further include server 108 which may be communicably linked to all other the other devices within system 100 through wide area network 106, which may be implemented as, for example, the Internet. Server 108 may be implemented as evidence lifecycle management (ELM) Analytics server. Server 108 may be communicably linked, either directly or indirectly with storage device 110. Server 108 may be implemented within a “cloud” architecture or “on premises” architecture. While ELM is described herein as evidence lifecycle management, it may be appreciated that matters within system 100 are not limited to evidence lifecycle management and may be matters unrelated to evidence lifecycle management.

Computing devices 122, 124 may be implemented as related parties to the corporation managing server 102 in the same matter. For example, related parties may include outside legal counsel for the corporation, other corporations that are a party to the litigation, i.e., co-defendants or co-plaintiffs, etc. Computing devices 122, 124 may access server 108 through network 106. In addition, Computing devices 122, 124 may provide information, indirectly, through network 106 to server 102.

Computing devices 126, 128 may be implemented by non-related parties to the corporation managing server 102. Computing devices 126, 128 may access server 108 through network 106.

System 100 may further include servers 130, 134. Servers 130, 134 may be communicably linked to storage devices 132, 136, respectively. Servers 130, 134 may be implemented as any type of public organization that offers information to the public, for example, federal or state regulatory agencies, legal research databases including Westlaw, Lexis, Thomson, Pacer, etc. Servers 130, 134 may be accessed at least by server 108 through network 106 as discussed herein.

Computing devices 112, 118, 122, 124, 126, 128, may be implemented as a personal computer, a workstation, or any personal handheld device, i.e., a Personal Digital Assistant (PDA), a cellular telephone, or any other device that is capable of operating, either directly or indirectly, on network 105 and/or 106 as discussed herein. Computing devices may include (not shown) memory, a network interface application, secondary storage, application software, central processing unit (CPU), and input/output devices. Network interface may be implemented as any conventional browser application to facilitate interaction with applications on server 102 and/or 108 as discussed herein. Application software may include matterspace application as discussed herein. In addition, application software may include an application facilitating interaction with ELM analytics server 108 as discussed herein. Input/output devices may include, for example, a keyboard, a mouse, a video cam, a display, a storage device, and/or a printer. Computing devices 112, 118, 122, 124, 126, 128 may be communicably linked with server computer 102 and/or 108 using application software as discussed herein.

Server 102 may include (not shown) CPU, memory, input/output devices, secondary storage, network interface application, and application software including matterspace application as discussed herein.

Server 108 may include (not shown) CPU, memory, input/output devices, secondary storage, network interface application, ELM Analytics application, and matterspace application facilitation communication with instances of matterspace application at computing devices 112, 118, 122, 124, 126, 128.

### Matterspace Architecture

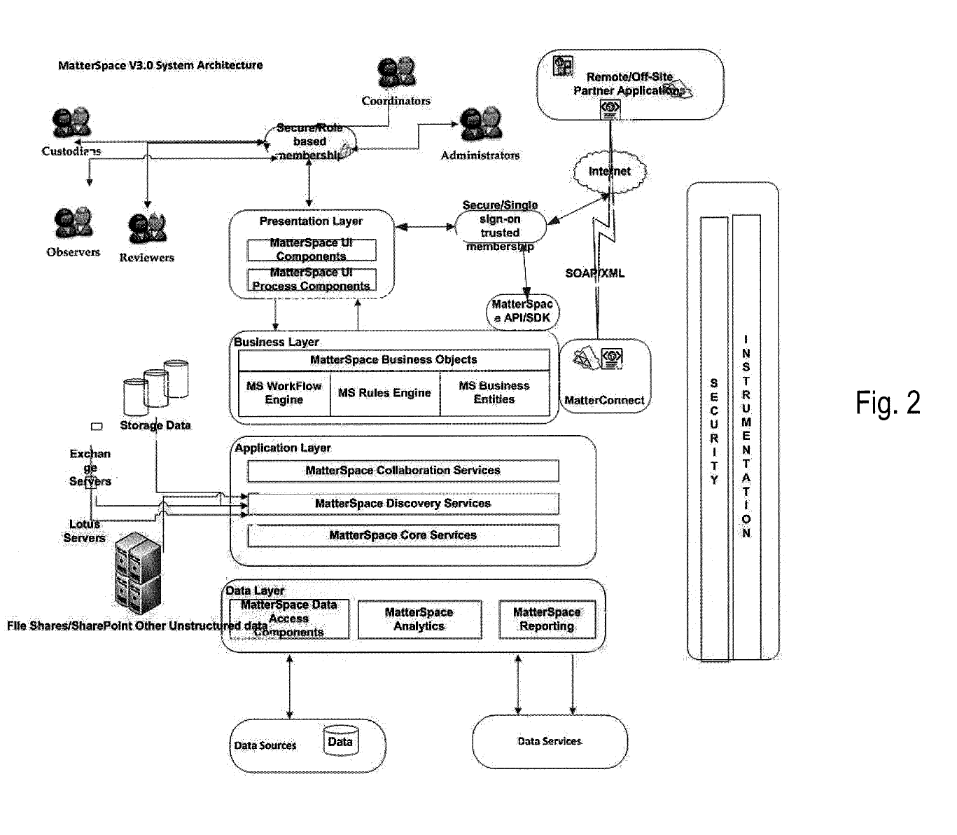

FIG. 2 depicts and example architecture for matterspace application consistent with the principles of some embodiments of the present disclosure. Matterspace application may be implemented at server 102 and be accessed by computing devices 112, 118, and server 108. Matterspace application may receive information regarding a matter from computing devices 122, 124.

Matterspace application may automate and manage the lifecycle of evidence for corporate litigation and/or investigations. A matter may be created utilizing matterspace application by receiving information associated with the matter, for example, the name of the matter, parties involved in the matter, issue(s) involved with the matter, timing involved in the matter including the case start date, the preservation start date, etc., potential awards in the matter, key search terms, a code value indicating the type of matter, member management, etc.

As shown in FIG. 2, custodians, observers, reviewers, coordinators and administrators may have a secure, role-based membership to matterspace application. This membership may be directed to a particular matter or for all matters. Custodians, observers, reviewers, coordinators and administrators may access matterspace through computing devices 116, 120.

In addition, remote, off-site partner applications may, through network 106, may have a secure, single sign-on trusted membership to access matterspace application. Remote, off-site partners may be implemented as computing devices 122, 124.

A new matter may be opened within matterspace. When opening a new matter, roles such as Custodians, observers, reviewers, coordinators and administrators may be assigned, phases, steps and tasks may be determined thereby providing a workflow, dashboards may be dynamically generated based on the workflow, and the phases, steps, and/or tasks may be assigned to a particular person or role, as discussed herein. As the matter progresses, additional information may be provided from the people performing the phases, steps and/or tasks. In addition, trend analysis on current and/or past cases (stored for example, in storage device 104 and/or storage device 110), related or unrelated, may be performed and stored in association with the new matter. All of the information regarding the new matter may be stored, for example in storage device 104. In addition, all of the information regard the new matter may be stored through server 108 in storage device 110.

### 1. Presentation Layer

Presentation layer provides for matterspace user interface (UI) components and matterspace UI process components through which computing devices 116, 120 may interface with matterspace application.

### 2. Business Layer

Business layer 210 includes matterspace business objects. Matterspace business objects include matterspace work flow engine, matterspace rules engine and matterspace business entities.

a. Matterspace Workflow Engine

Workflow engine creates, monitors and/or manages a workflow for each matter. A workflow includes at least one phase, at least one step per phase and may alternatively include at least one task per step. Each phase, step and/or task may have information associated therewith, for example, whether it will be performed automatically or manually, the name and/or role of the person assigned thereto, the status of completion, comments associated therewith, rules associated therewith, etc.

A workflow may be manually created by, for example, an administrator. Alternatively, a default workflow may be utilized, wherein the default workflow includes default phases, steps and tasks associated with a generic matter, litigation, investigation, etc.

Alternatively, a workflow may be dynamically generated based on past or current matters. These past and/or current matters may be accessed at storage device 104. It may be appreciated that the past and/or current matters stored at storage device 104 may be matters relating to the corporation managing server 102. As such, confidential information with respect to the matters may be available to server 102. It may be appreciated that the functionality of the workflow engine may be performed at server 108, wherein past and/or current matters may be accessed at storage device 110 by server 108. It may further be appreciated that the past and/or current matters stored within storage device 110 may be matters related to the corporation managing server 102, or not. If, during the dynamic generation of the workflow and dashboard, past and/or current matters are accessed that are not related to the corporation managing 102, confidential information may be scrubbed, while non-confidential information may be utilized.

In dynamically generating a workflow, for example, a user may search past or current matters, using particular search criteria, in order to identify certain phases, steps and/or tasks that have been used in similar cases. The phases, steps, and/or tasks may then be ranked based on ranking criteria in order to select the most appropriate phases, steps, and/or tasks. Ranking may be based on, for example, whether the past or current matter is settled, favorably decided, within budget, whether the phase, step or task is completed, degree of completion of phase, step or task, whether phase, step or task was manually or automatically performed, how many different matters utilized the phase, step or task, whether a predetermined percentage of different matters utilized the phase, step or task, the name or role of who performed the phase, step or task, etc. Certain phases, steps, and/or tasks may be selected based on, for example, top ranking. The selected phases, steps, and/or tasks may then be utilized in generating the workflow. It may be appreciated that these selected phases, steps and/or tasks may be added to default phases, steps and/or tasks when the workflow is generated.

It may be appreciated that system may, in selecting a workflow or components of a workflow, determine a percentage of times a phase, step or task was, for example, included in a workflow, completed, manually or automatically completed, etc. The system may further determine whether the percentage exceeds a predetermined threshold and may select one or more components based on a determination that the percentage exceeds a predetermined threshold.

A user interface, for example, a dashboard, may then be created based on the selected phase, steps, and/or tasks and the workflow generated with the selected components. The user interface may be displayed at computing devices within system 100 and used by users in order to view, enter, manage, etc., information regarding matters. In addition, roles may be assigned, for example, based on the assignment of the person or role that completed the task in the past or current matter. Alternatively, roles may be assigned manually by, for example, an administrator.

It may be appreciated that this process may be utilized to dynamically generate a workflow and dashboard for all of the phases, steps and/or tasks within a matter.

Alternatively, a workflow and dashboard may be dynamically generated based on, for example, the role of the user. For example, a corporate employee at computing device 112, or 118 may request a dynamically generated dashboard that is generated based on the role of the user. In this example, all of the phases, steps, and/or tasks that the user has access to based on role, permission, etc., may be determined and utilized in generating a workflow and dashboard for that particular user. The phases, steps and/or tasks that may be included in the dashboard of a particular user may be selected from the set of phases, steps and/or tasks that have been selected for the new matter. Thus, the dashboard at computing device 112, 118 may have a subset of the phases, steps and/or tasks in the dashboard that includes the entire workflow. Similarly, the workflow and dashboard may be dynamically generated for users at computing devices 122, 124.

Alternatively, all of the dashboards within system 100 may have different components wherein only the phases, steps and/or tasks that are assigned to the user of the computing device may be included in the dashboard.

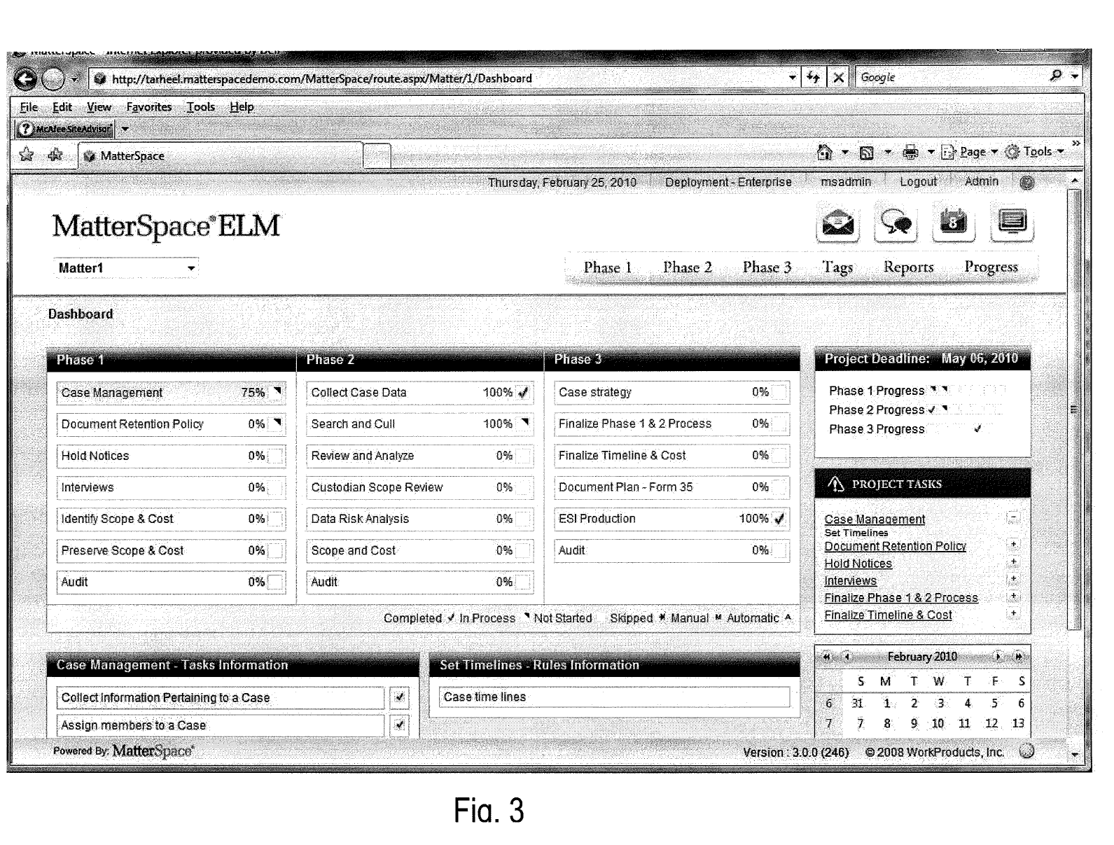

FIG. 3 depicts an example screen shot of a dashboard consistent with the principles of some embodiments of the present disclosure. As can be seen in FIG. 3, “Matter1” includes three phases, each phase having a number of steps. Phase 1 has seven steps. As can be seen in FIG. 3, step “case management” is in process and is 75% completed, while the other six steps in Phase 1 have not been completed. Case Management has two tasks depicted, “collect information pertaining to a case” and “assignment members to a case,” both of which have been completed. Step “set timelines” (not shown) has rules information associated therewith, namely “case time lines”.

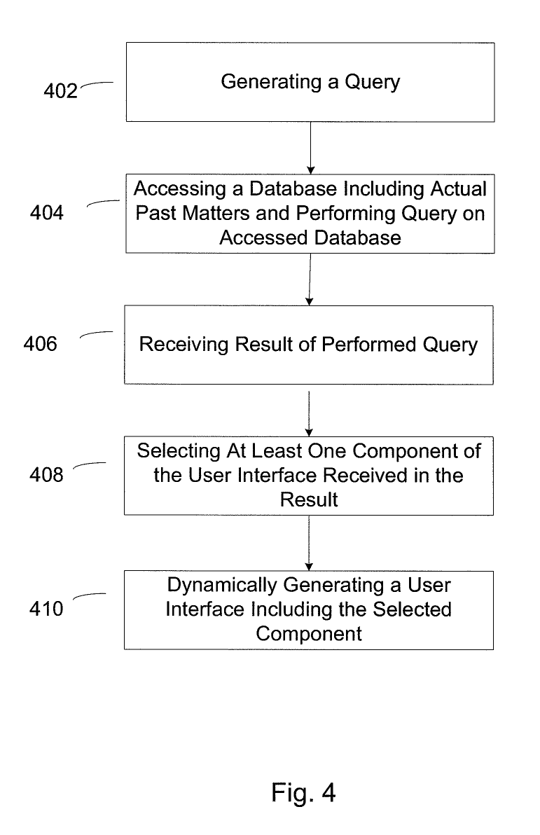

FIG. 4. depicts an example flow diagram of the steps performed by server 102 in dynamically creating a workflow and dashboard consistent with the principles of some embodiments of the present disclosure. As shown in FIG. 4, a query is generated (Step 402). This query may be generated based on information associated with a new matter that is being created in matterspace application. This information may include information identifying at least one of a current matter type, issue, a potential damage award, a potential total cost, other matter/project-related information, information identifying a person and/or a role of a person, etc.

Server 102 may then access a storage device that stores information related to current and/or past matters, for example, database 104, and perform the query on the storage device (Step 404). A past matter may be a matter that was previously opened and but now closed, or completed. This past matter may be a matter that has been settled, tried and decided, etc. A current matter may be a matter that has been opened but not closed or completed. The current matter may be a matter that is opened in anticipation of a legal action or trial, that is opened based on receipt of a complaint, etc.

Each of the current and/or past matters may be searched to determine which current and/or past matters satisfy the query. The search result may include one or more phases, steps and/or tasks that satisfy the query. For example, current and/or past matters may be searched to identify those matters that are similar to the new matter, for example, in issue, scope, cost, potential award, etc. The workflow, either completely or selected components thereof, may be utilized in dynamically creating a workflow for the new matter.

The search results may then be received at server 102 (Step 406). The workflow, or components thereof, may be ranked as noted above and then selected (Step 408). The dashboard may then be dynamically created including the selected component(s) (Step 410).

A person and or role may then be assigned to each of the steps and/or tasks included in the workflow. The person and/or role may be assigned based on the person or assigned to the step and/or task in the current or past matter. Alternatively, the person and/or role may be assigned manually by an administrator. Alternatively, a default role may be assigned.

b. Matterspace Rules Engine

Matterspace rules engine stores and provides rules for operating the workflow. In addition, matterspace rules engine may store and provide rules that are associated with tasks to be performed. These rules may appear in the user interface, or dashboard, to assist users in performing tasks within the workflow.

The rules engine may further provide rules for determining document retention, i.e., preserve only (for example, obtain information about the data without collecting the data), preserve and collect (for example, obtain information about the data and collect the data), or collect only (for example, collect the data). Additional information may further be provided, for example, the first and last accessible date.

c. Matterspace Business Entities

Matterspace business entities communicates with data access components and data sources in order to perform the functionality as discussed herein based on business logic associated with matters, as may be appreciated by one skilled in the art.

d. Matterconnect

Matterconnect enables matterspace to interface with third party applications, for example, human resources applications, invoicing applications, data retention archives, policy engines, discovery review applications, etc. Using the interface, information from third party applications may be imported into matterspace and utilized in the functionality as discussed herein. For example, a human resources application may include a list of employees, titles, dates of employment, etc. This information may be imported and stored within matterspace, wherein phases, steps, and/or tasks may by assigned to employees based on this information.

### 3. Application Layer

Application layer 220 includes matterspace collaboration services, matterspace discovery services and matterspace core services.

It may be appreciated that application layer may provide for the ability of ELM Analytics to interface with matterspace in order to perform the functionality as discussed herein.

a. Matterspace Collaboration Services

Matterspace collaboration services enable users working within the same matter, but at different computing devices, to provide information to the system. These users maybe operating at, for example, computing devices 112, 118, 122, 124.

b. Matterspace Discovery Services

Matterspace discovery services include a crawler that crawls one or more storage devices, for example, storage devices 116, 120.

A document retention schedule may be accessed per data storage device, for example, a mass data storage device, per data custodian, etc., and provided in a data map representing a list of collections. The rules engine may be accessed to determine what the retention policy is, for example, preserve (wherein only information about the data is determined), preserve and collect (wherein information about the data is determined and the data is collected), or collect (wherein the data is collected). In addition, rules may be determined regarding whether the crawled data should be tagged. Thus, before invoking a crawl for a particular data source or custodian in a new matter, if the specific tagged (for example, Relevant, etc.) file in other identified matters shows up in the new matter it is automatically given the specific tag (Relevant, etc.) from the other identified matters.

Reminders may be provided regarding dates that a source files might be inaccessible (fully deleted or written to backup tape) to determine when such (tagged) files need to be collected.

Pre-Collection Report per matter may be performed to check to see if a pertinent source or custodian information has already been crawled and collected in another (past and/or current) matter to allow usage of that collected information. Alternatively, the data source may be recrawled.

During the crawling process, the data may assessed for tagging indicating, for example, further in-depth review will be performed later. The system may cull before searching and has all known meta types available in the UI before search for the purpose of quick cull. Data may be select by custodian, doc type, create year, recipients, or any other “known” META data type.

System may be able to save searches thereby providing the capability to schedule crawls to run automatically (i.e., a repeating event) for day-forward preservation and/or collection, with additional ability to tag the search results automatically based on how the documents were tagged in the first crawl.

Where more than one storage device is crawled, information may be stored with respect to each storage device or may be stored with respect to all of the crawled data in total.

Once the data has been crawled, it may be analyzed in order to determine and provide a “chain of custody” with regard to each document found during the crawl. The chain of custody may include the original author of the document, date of creation, contributors to the contents of the document, dates of contributions, size of the document, a path identifying the location of the document, whether the document was collected, etc. This chain of custody may be provided to the user through the user interface. The chain of custody may be updated, for example, when another crawl is performed and there is further access and/or modifications to the document.

The chain of custody may be provided for each document of each custodian. When a document is first crawled, a hash value may be calculated for each document of each custodian. When a crawl is repeated, a new hash value is calculated and compared with a hash value that was calculated when the document was first crawled. If the new hash value does not match the hash value of the first crawl, then this indicates that there has been a change to the document. Thus, the document may be preserved and/or collected. If the new hash value matches the hash value of the first crawl, then this indicates that there has been no change to the document and no additional information is collected for this document. This comparison may be performed each time a crawl is performed. Thus, the crawl functionality may be automatically implemented on a periodic basis in order to preserve and/or collect changes to documents.

c. Matterspace Core Services

Matterspace core services, as may be appreciated by one skilled in the art, performs basic functions to support other modules within matterspace, including logging, reporting, exception handling, security, etc.

### 4. Data Layer

a. Matterspace Data Access Components

Data access components facilitate the entry, access and management of data stored in communicably linked storage devices. Data stored in data sources, which may be implemented as storage device 104, may include information regarding one or more matters, and for each matter, data may be stored regarding case type, issue(s), keywords, time schedules, workflow, including phase, step, task, responsible part(ies) for performing the phase, step and task, forms, documents, notices, interrogatories and communications which may be associated with phases, steps, and/or tasks, crawled data information, and other information as discussed herein.

b. Matterspace Analytics

Matterspace analytics provides for the ability to access and analyze data stored within a storage device in order to provide recommendations, predictions, trends, etc., to a user regarding a current and/or past matter.

For example, matterspace analytics may perform scope and cost analysis with respect to matters stored within storage device 104. The process for performing the analysis is similar to the process discussed below with regard to the ELM Analytics.

In addition, information accessed and analyzed within matterspace analytics may be used for reporting purposes, to determine scope and cost, to perform trend analysis, process trend analysis, phase, step, task trend analysis, search query analysis, tag trend analysis, etc.

It may be appreciated that the search analytics may be performed at tag level, at the ELM analytics, at phase, step, task level, or any other type of computation or analysis as discussed herein.

### ELM Analytics Architecture

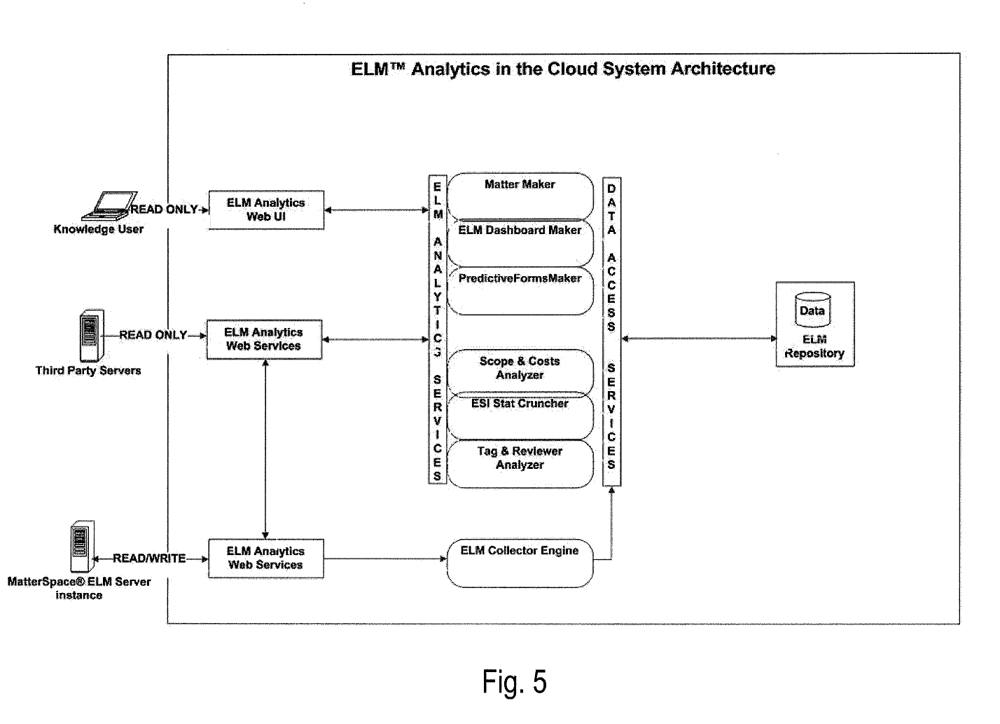

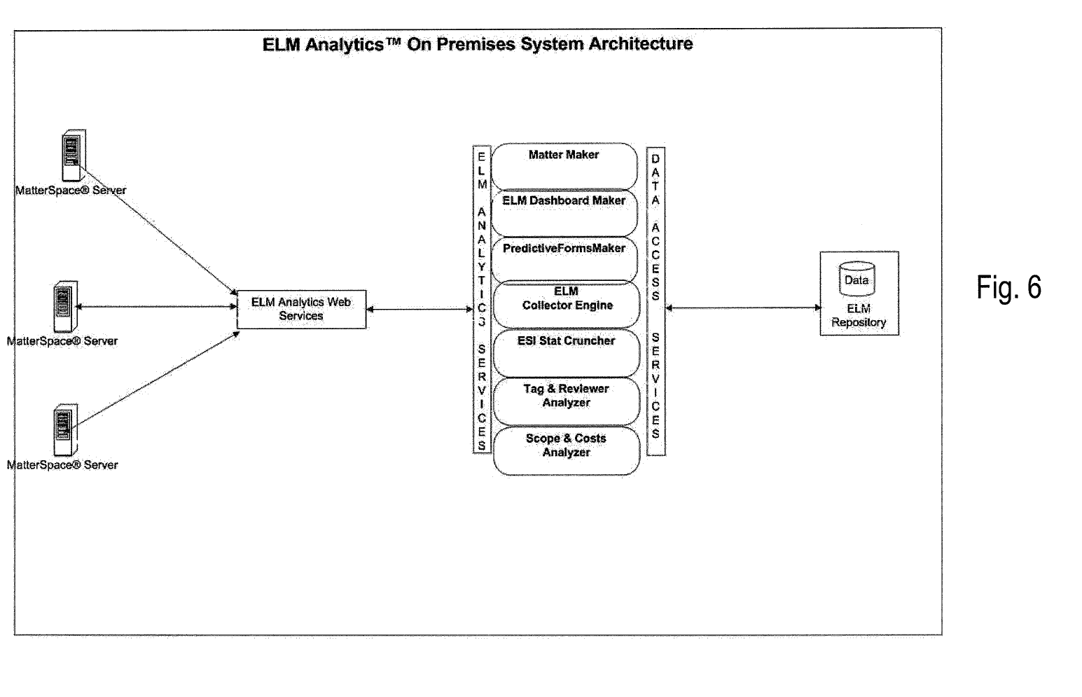

FIG. 5 depicts an example diagram of ELM Analytics in the cloud architecture, consistent with the principles of some embodiments of the present disclosure. FIG. 6 depicts an example diagram of ELM Analytics on the premises architecture, consistent with the principles of some embodiments of the present disclosure. It may be appreciated that the functionality of the components discussed with regard to FIG. 5 are similar to the functionality of the components within FIG. 6.

ELM analytics application may be implemented at server 108 and may access and be accessed by computing devices 102, 112, 118, 122, 124, 126, 128, 130 and 134.

As shown in FIG. 5, ELM repository is provided and may be implemented by database 110. ELM repository may include information regarding all matters within system 100, including matters (new, past and/or current) that are associated with corporate legal server 102, and other non-related parties to corporate legal 102. This information may include some or all of the information in storage device 104. It may further include similar information with regard to other, non-related corporate entities in non-related matters.

As shown in FIG. 5, ELM Analytics includes mattermaker, dashboard maker, predictive forms maker, scope and costs analyzer, stat cruncher, tag and reviewer analyzer and ELM collector engine.

1. Matter Maker

Matter maker facilitates the creation of a matter at the ELM Analytics. The information that may be provided may be similar or the same information that is noted above with regard to matterspace.

2. Dashboard Maker

The dashboard maker may include functionality similar to the functionality discussed above with regard to the workflow engine in FIG. 2. However, the storage device accessed by the dashboard maker may be storage device 110, wherein the dashboard may be dynamically generated based on matters that a corporation was a party to, and/or also matters that the corporation was not a party to. It may be appreciated that when accessing and/or providing information of non-related parties in the ELM repository, confidential information related to that matter may be scrubbed and not provided. Examples of such information name include the names of parties, names of individuals associated with the matter, phase, step and/or task, confidential information in forms and/or documents associated with the matter, etc.

In dynamically generating a dashboard at ELM Analytics, a query is generated. This query may be based information that is provided from, for example, server 102, computing devices 116, 120, 122, 124, 126, 128, etc. This query may be generated based on information associated with a new matter that is being created in matterspace application at computing devices 116, 120, 122, 124, 126, or 128. This information may include information identifying at least one of a current matter type, issue, a potential damage award, a potential total cost, other matter/project-related information, information identifying a person and/or a role of a person, etc.

ELM Analytics may then access a storage device that stores information related to current and/or past matters, for example, database 110, and perform the query on the storage device. The current or past matters may be matters that a corporation was a party to and/or matters that the corporation was not a party to.

Each of the current and/or past matters may be searched to determine which current and/or past matters satisfy the query. The search result may include one or more phases, steps and/or tasks that satisfy the query. For example, current and/or past matters may be searched to identify those matters that are similar to the new matter, for example, in issue, scope, cost, potential award, etc. The workflow, either completely or certain components thereof, may be utilized in dynamically creating a workflow for the new matter.

The search results may then be analyzed. The workflow, or components thereof, may be ranked as noted above and then selected. The dashboard may then be dynamically created including the selected component(s).

A person and or role may then be assigned to each of the steps and/or tasks included in the workflow. The person and/or role may be assigned based on the person or assigned to the step and/or task in the current or past matter. Alternatively, the person and/or role may be assigned manually by an administrator. Alternatively, a default role may be assigned.

3. Predictive Forms Maker

The predictive forms maker provides the ability to dynamically generate or access forms that may be predicted to be appropriate for a new matter. It may be appreciated that the functionality of the predictive forms maker may also be realized at server 102, wherein the forms may be predicted based on the matters stored within storage device 102.

The storage device accessed by the predictive forms maker may be storage device 110. Predictive forms may be dynamically generated based on matters that a corporation was a party to, and/or also matters that the corporation was not a party to. It may be appreciated that when accessing information of non-related parties in the ELM repository, confidential information related to that matter may be scrubbed and not provided. Examples of such information name include the names of parties, names of individuals associated with the matter, phase, step and/or task, confidential information in forms and/or documents associated with the matter, etc.

In dynamically generating predictive form(s) at ELM Analytics, a query is generated. This query may be based information, for example, attribute information as discussed herein, that is provided from, for example, server 102, computing devices 116, 120, 122, 124, 126, 128, etc. This query may be generated based on information associated with a new matter that is being created in matterspace application at computing devices 116, 120, 122, 124, 126, or 128. This attribute information may include information identifying at least one of a current matter type, issue, a potential damage award, a potential total cost, other matter/project-related information, information identifying a person and/or a role of a person, etc.

ELM Analytics may then access a storage device that stores information related to current and/or past matters, for example, database 110, and perform the query on the storage device. The current or past matters may be matters that a corporation was a party to and/or matters that the corporation was not a party to.

Each of the current and/or past matters may be searched to determine which current and/or past matters satisfy the query. The search result may include one or more phases, steps and/or tasks that satisfy the query. For example, current and/or past matters may be searched to identify those matters that are similar to the new matter, for example, in issue, scope, cost, potential award, workflow, etc. The search results may include forms that were used in the past and/or current matters. The search results may further, or alternatively, include one or more interrogatories or questions that may be used to generate one or more forms.

The search results may then be analyzed. The forms and/or interrogatories may be ranked, for example, based on attribute information, as noted above and then selected based on the ranking. The selection may be based on whether the matter was successful, completed, settled, an amount of an award or settlement, a potential award or settlement, a degree of completion of the past and/or current matter, etc. The forms may then be dynamically created including the selected interrogatories. The forms may further include interrogatories or questions that have been selected by a user. Alternatively, the complete form itself, as stored in association with the current and/or past matter and may be provided in response to the query. The form may then be provided to the user, for example, displayed on a display, as a recommendation based on the request and/or query.

4. Scope and Costs Analyzer

Scope and costs analyzer analyzes information regarding the data crawled by the discovery services in matterspace.

The system provides for the functionality of reviewing past and/or current matters in order to identify matters similar to the new matter. Information regarding a new matter may then be inferred based on the information regarding the past and/or current matter(s).

A user, such as a Coordinator, may perform the first cost analysis for the matter, which may be used for making ‘Try vs. Settle’ decisions in the litigation. This is early in the process, but after Hold Notices have been issued and Interviews conducted, the scope of the matter project begins to take shape. It may be appreciated that a cost analysis may be performed at any time during pendency of a matter.

Coordinators may provide some data in the user interface in order to obtain meaningful calculations. Other data may be pre-populated based on the information obtained by crawling the storage devices.

A description of each item is listed below:
Number of custodians—this is determined by the actual number of Custodians assigned to the matter.
Per-Custodian License Cost—input box, total per-custodian cost of licenses including MatterSpace.
Estimated Total Data Size (in GB)—this is calculated based on inputs in this section.
Emails Size (in GB)—input box, estimated total size of all mail for all custodians
Avg. MSG Size (KB)—input box, default is 35 KB.
Avg. pages per file—input box, estimated number of pages per item
Files Size (in GB)—input box, estimated total size of all files for all custodians
Avg. File Size (MB)—input box, no default
Avg. pages per file—input box, estimated number of pages per item
SharePoint Size (in GB)—input box, estimated total size of all SharePoint files for all custodians
Avg. File Size (MB)—input box, no default
Avg. pages per file—input box, estimated number of pages per item
Other Size (in GB)—input box, estimated total size of all Other files types for all custodians
Avg. File Size (MB)—input box, no default
Avg. pages per file—input box, estimated number of pages per item
Current Identify/Preserve Costs—input box, estimated current costs to date for the matter
Number of pages reviewed per hour—input box, default 50, estimated number of pages that can be reviewed by a lawyer per hour
Lawyer rate per hour—input box, no default
Case Value—this is obtained from the Case Management information
Damages Value—this is obtained from the Case Management information
% Threshold to settle—input box, 15% default. Most companies don't want to manage to the exact cost of a matter, since there are usually variables that might cause cost overruns. In addition, if it's going to cost $100K to manage a $100K case, there is no savings so it could be decided to settle just to save the effort.
Dedup %—input box, no default. This is the estimated amount of storage savings based on duplicate records, thus reducing the number of documents that need to be produced and reviewed.
Cull %—input box, no default. This is the estimated amount of reduction during Phase 2: Early Case Assessment Search/Cull/Analysis efforts.

From all of this data, calculations may be performed, for example, one that considers damages, one that does not consider damages, etc. The calculations are as follows:
Current Cost Estimate: This is the estimated cost based on License costs, current Preservation costs, as well as determining the number of pages to be reviewed and the cost to have that done.
Case Threshold Value: This is cost to manage to. It is the Case Value minus the Threshold Value.
Difference: This is the difference+/−the Case Threshold Value.
   If within budget the values are displayed, for example, in Green.
   If outside budget constraints the values may be displayed for example, in Red.
Threshold Value: This is Threshold % against the Case Value, or simply put, the savings target amount.

### Preserve Scope & Cost

In this area in the interface (not shown) users, such as Coordinators, perform additional cost analysis for the matter. The only difference from the previous step is the following:
Estimated cost for Collection: input box, no default. Estimated additional costs for data collection.
Estimated cost to Search/Cull/Analyze/Review: input box, no default. Estimated additional costs for Phase 2 Early Case Assessment efforts.
Collect Miscellaneous Costs: input box, no default. Estimated additional miscellaneous costs.

An example of the calculations that may be performed to show the costs are as follows:

if (emailAvgSize!=0 && emailPagePerFile!=0)
nrPages+=(emailPercent*1024*1024)/emailAvgSize/emailPagePerFile;

if (fileAvgSize!=0 && filePagePerFile!=0)
nrPages+=(filePecent*1024)/fileAvgSize/filePagePerFile;

if (sharePointAvgSize!=0 && sharePointPagePerFile!=0)
nrPages+=(sharePointPecent*1024)/sharePointAvgSize/sharePointPagePerFile;

if (otherAvgSize!=0 && otherPagePerFile!=0)
nrPages+=(otherPecent*1024)/otherAvgSize/otherPagePerFile;
double currentEstimate=nrCustodians*perCustodianLicense+currentCost+(nrPages*lawyerRate)/pagesReviewedPerHour;
double thresholdValue=double.Parse(uxThresholdPercent.Text)*caseValue/100;
double currentThresholdValue=caseValue−thresholdValue;
double differenceCost=currentEstimate−currentThresholdValue;
double thresholdValueDamages=double.Parse(uxThresholdPercent.Text)*(caseValue+damagesValue)/100;
double currentThresholdValueDamages=caseValue+damagesValue−thresholdValue;
double differenceCostDamages=currentEstimate−currentThresholdValueDamages;

FIG. 6 depicts an example screen shot of a scope and cost interface consistent with the principles of some embodiments of the present disclosure.

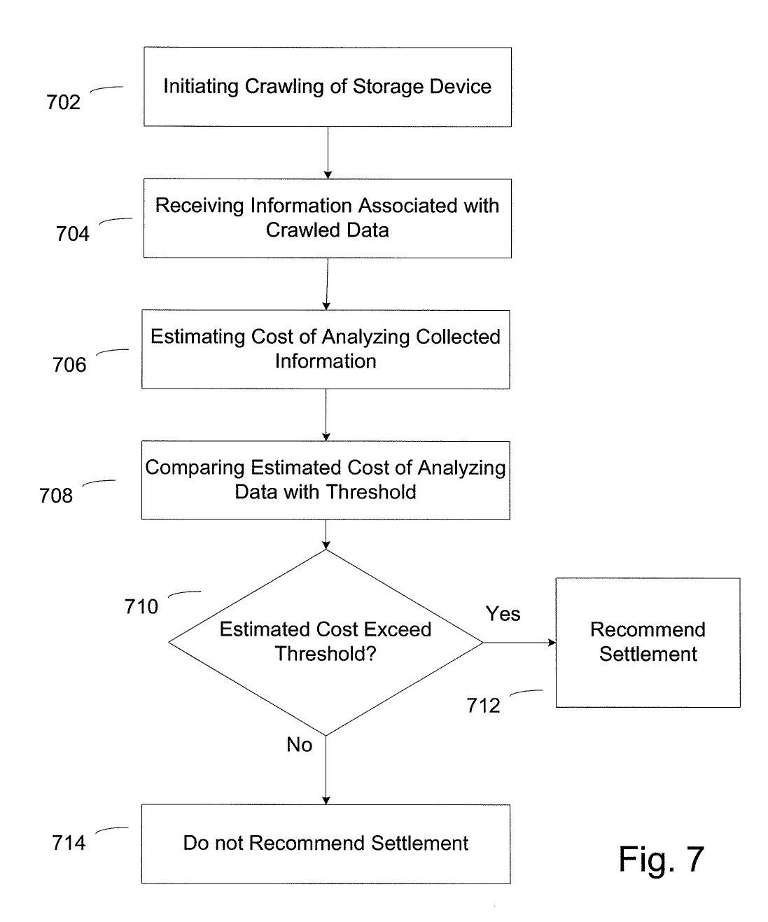

FIG. 7 depicts an example flow diagram of a method for analyzing scope and cost consistent with the principles of some embodiments of the present disclosure. As shown in FIG. 7, the system may initiate crawling of one or more data storage devices (Step 702). These data storage devices may be storage devices that include information that may need to be reviewed for potential discovery in litigation. The storage device may be crawled as noted above. After the storage device is crawled, information is received regarding the data within the crawled storage device (Step 704).

Based on the information received, a cost of analyzing the information within the storage device is estimated (Step 706). This estimation may be based on a search of data of analogous matters within storage device 110 and may be based on past or current matters, related or non-related. This information may be accessed from the ELM collector engine as discussed below. In other words, a search may be performed at storage device 110 using at least one of the same issues, case type, potential awards, amount of crawled data to be analyzed, etc. Matters matching the search query may then be analyzed to determine the cost of analyzing the data within the matching past or current matter(s). These numbers maybe, for example, averaged to estimate a cost of analyzing the data.

The estimated cost of analyzing the data is then compared with a predetermined threshold (Step 708). This predetermined threshold may be based on information input by a user when, for example, creating the new matter. The predetermined threshold may be based on a potential award, a total cost budgeted for the matter, etc.

A determination is then made whether the estimated cost exceeds the predetermined threshold (Step 710). If the cost exceeds the threshold (Step 710, Yes), then the system may provide a recommendation (Step 712). This recommendation may be, for example, to settle.

If the cost does not exceed the threshold (Step 710, No), then the system may provide a different recommendation (Step 714), for example, proceed with the matter, proceed to trial, etc.

5. Stat Cruncher

The stat cruncher provides the ability to access and analyze data stored within a storage device in order to provide recommendations, predictions, trends, etc., to a user regarding a current and/or past matter.

For example, stat cruncher may assist with performing scope and cost analysis as noted above with respect to matters stored within storage device 110. The process for performing the analysis is similar to the process discussed above with regard to matterspace.

In addition, information accessed and analyzed within ELM analytics may be used for reporting purposes, to determine scope and cost, to perform trend analysis, process trend analysis, phase, step and task trend analysis, search query analysis, tag trend analysis, etc.

It may be appreciated that the search analytics may be performed at tag level, at matterspace, at phase, step, task level, or any other type of computation or analysis as discussed herein.

6. Tag and Reviewer Analyzer

Tag and reviewer analyzer analyzes documents that are tagged, for example, with regard to each document, a tag is analyzed to determine, for example, who is reviewer, what was the role of the reviewer, what documents were tagged, how long was reviewer at the company, was the tag associated with other tags, what are characteristics of tags, etc. this information is then used to perform trend analysis, scope and cost analysis, etc.

7. ELM Analytics Collector Engine

The ELM analytics collector engine may be used to interface with instances of matterspace applications in order to maintain real-time information related to new and/or current matters. For example, when a new matter is created, the ELM collector engine may interface with the matterspace application in order to obtain all information regarding the new matter. This information may be stored in storage device 108. When new information is provided by server 108, computing devices 112, 118, etc., the information may, in real time, periodically, etc., be accessed by the ELM collector engine, processed and stored within ELM repository, for example, storage device 110.

It may be appreciated that computing devices 122, 124, which are operated by related parties to the new matter at matterspace application at 102, may be operating a separate instance of matterspace application at computing devices 122, 124. Computing devices 122, 124 may be operating with a dashboard that is generated including only those components that the user at computing device 122, 124 is permissioned and/or assigned. Information may be input at computing devices 122, 124 in response to the components of the dashboard, for example, phases, steps and/or tasks. This information may be provided to the ELM collector engine, operating either in the cloud architecture or on the premises architecture, for storage in association with the new matter at storage device 110. In addition, this information may be provided, through ELM collector engine, to server 102 for storage in storage device 104. In other words, server 108 may provide an interface between computing devices 122, 124 in order to update information regarding a new and/or current matter.

It may be appreciated that information regarding a matter may be stored with all of the confidential information associated therewith. Alternatively, some of the information, including at least one of the attribute information, phases, steps, tasks, may be modified to remove the confidential information associated therewith.

In addition, the ELM collector engine may, in conjunction with other modules, be used to access information regarding past and current matters in order to generate predictions, inferences, recommendations, trends, scope and cost analytics, etc., as discussed herein. The collector engine may interface with storage device 110 in order to search for past and/or current matters that satisfy certain search criteria. Based on the past and/or current matters in the search results, information associated with the past and/or current matters in the search results may be analyzed in order to generate information regarding a new matter.

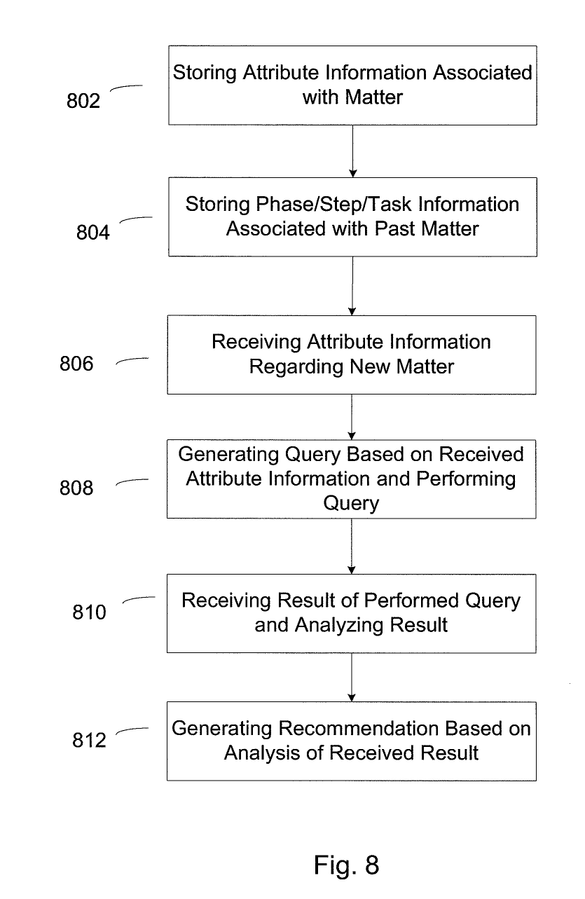

FIG. 8 depicts an example flow diagram of a method for generating a recommendation consistent with the principles of some embodiments of the present disclosure.

As shown in FIG. 8, attribute information may be associated with a past and/or current matter (Step 802). The attribute information may be any information associated with the matter, for example, case type, issue(s), key word(s), or any other information noted above with regard to the matter. In addition, phase/step/task information is stored and associated with each past and/or current matter (Step 804). The phase/step/task information includes details of not only the phase/step/task, but also the name and/or role of the person who performed the phase/step/task, any information provides by the performer of the phase/step/task, whether it was completed manually or automatically, etc.

The system may receive information regarding attribute information of a new matter (Step 806). A query may be generated based on the attribute information of the new matter (Step 808). The generated query may be performed at the storage device storing the current and past matters. In other words, the system is searching for past and/or current matters that are similar to the new matter.

The system then receives the result of the query and analyzes the result (Step 810). Based on the analysis of the search results, the system generates a recommendation for the new case (Step 812).

The recommendation may be related to trend information. For example, the system may analyze the search results to determine a trend for settlement in a certain type of case, instead of proceeding to trial; the system may determine that a certain form is consistently used for cases that have won at trial; the system may determine that a certain set of interrogatories is consistently used for cases that have won at trial, etc.

For another example, the results may be analyzed to determine if the majority of the cases, which are similar based on the searched attribute information, won at trial, resulted in a favorable settlement, etc. This information may be used to determine a likelihood of success and thereby provided as a recommendation.

By providing for the features as discussed herein, a new matter may operate based on activities that occurred in other past and/or current matters. As such, a new matter may benefit from the achievements and/or failures of other past and/or current matters. Beneficial phases, steps, and/or tasks may be predicted from current and/or past matters that may be used to create a workflow, and thus the dashboard or interface for a new matter. In addition, analytics may be performed based on similar past and/or current matters in order to predict whether to proceed or settle a new matter. In addition, the actions of members in a workflow maybe monitored and recorded, wherein the discovery process may take place in accordance with certain rules and procedures.

### CONCLUSION

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wireless sly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

I claim:

1. A method for dynamically generating a user interface, comprising:
receiving information identifying at least one of a current matter type, issue, a potential damage award, a potential total cost, other matter-related information, and information identifying a person;
generating a query including the received information;
accessing a database including actual past and/or current matters, each of the actual past and/or current matters having associated therewith at least related matter information and a user interface including a plurality of components;
performing the generated query on the accessed database;
receiving a result of the performed query including at least one past and/or current matter from the performed generated query and a plurality of components of a user interface associated with each received past matter;
selecting at least one component of the user interface associated with the identified past and/or current matter in the result; and
dynamically generating a user interface including the selected at least one component.

2. The method of claim 1, further comprising:
when the received result includes more than one user interface, ranking each of the components of each user interface based on information of the past and/or current matter associated with the component of the user interface, and selected at least one component based on the ranking.

3. The method of claim 2, wherein the ranking is performed based on at least one of a total cost, a potential total cost, an actual award and a potential award of the past and/or current matter associated with component of the user interface.

4. The method of claim 2, wherein the ranking is performed based on at least one of a determination of a degree of completion of the past and/or current matter associated with the component of the user interface.

5. The method of claim 1, wherein selecting at least one component further includes:
determining whether a phase, step and/or task associated with at least one of the plurality of components of the user interface of the received at least one past and/or current matter was performed manually or automatically; and
selecting at least one component based on the determination.

6. The method of claim 1, wherein selecting at least one component further includes:
determining a percentage of times a phase, step and/or task associated with at least one component was performed;
determining whether the percentage exceeds a predetermined threshold,
wherein at least one component is selected based on a determination that the percentage exceeds a predetermined threshold.

7. The method of claim 6, wherein the selected component is a task to be performed, the method further comprising:
determining, for the selected component, a custodian or a role of a custodian to be assigned to the component based on a custodian or a role of a custodian assigned to the component in a past and/or current matter; and
assigning the determined custodian or role of the custodian to the selected component.

8. An apparatus for dynamically generating a user interface, comprising:
a memory storing a set of instructions,
a processor configured to execute the stored set of instructions to perform a method comprising:
receiving information identifying at least one of a current matter type, issue, a potential damage award, a potential total cost, other matter-related information, and information identifying a person;
generating a query including the received information;
accessing a database including actual past and/or current matters, each of the actual past and/or current matters having associated therewith at least related matter information and a user interface including a plurality of components;
performing the generated query on the accessed database;
receiving a result of the performed query including at least one past and/or current matter from the performed generated query and a plurality of components of a user interface associated with each received past matter;
selecting at least one component of the user interface associated with the identified past and/or current matter in the result; and
dynamically generating a user interface including the selected at least one component.

9. The apparatus of claim 8, further comprising:
when the received result includes more than one user interface, ranking each of the components of each user interface based on information of the past and/or current matter associated with the component of the user interface, and selected at least one component based on the ranking.

10. The apparatus of claim 9, wherein the ranking is performed based on at least one of a total cost, a potential total cost, an actual award and a potential award of the past and/or current matter associated with component of the user interface.

11. The apparatus of claim 9, wherein the ranking is performed based on at least one of a determination of a degree of completion of the past and/or current matter associated with the component of the user interface.

12. The apparatus of claim 8, wherein selecting at least one component further includes:
determining whether a phase, step and/or task associated with at least one of the plurality of components of the user interface of the received at least one past and/or current matter was performed manually or automatically; and
selecting at least one component based on the determination.

13. The apparatus of claim 8, wherein selecting at least one component further includes:
determining a percentage of times a phase, step and/or task associated with at least one component was performed;
determining whether the percentage exceeds a predetermined threshold,
wherein at least one component is selected based on a determination that the percentage exceeds a predetermined threshold.

14. The apparatus of claim 13, wherein the selected component is a task to be performed, the method further comprising:
determining, for the selected component, a custodian or a role of a custodian to be assigned to the component based on a custodian or a role of a custodian assigned to the component in a past and/or current matter; and
assigning the determined custodian or role of the custodian to the selected component.

15. A computer-readable medium, storing a set of instructions, executed by a processor, to perform a method for dynamically generating a user interface, the method comprising:
receiving information identifying at least one of a current matter type, issue, a potential damage award, a potential total cost, other matter-related information, and information identifying a person;
generating a query including the received information;
accessing a database including actual past and/or current matters, each of the actual past and/or current matters having associated therewith at least related matter information and a user interface including a plurality of components;
performing the generated query on the accessed database;
receiving a result of the performed query including at least one past and/or current matter from the performed generated query and a plurality of components of a user interface associated with each received past matter;
selecting at least one component of the user interface associated with the identified past and/or current matter in the result; and
dynamically generating a user interface including the selected at least one component.

16. The computer-readable medium of claim 15, the method further comprising:
when the received result includes more than one user interface, ranking each of the components of each user interface based on information of the past and/or current matter associated with the component of the user interface, and selected at least one component based on the ranking.

17. The computer-readable medium of claim 16, wherein the ranking is performed based on at least one of a total cost, a potential total cost, an actual award and a potential award of the past and/or current matter associated with component of the user interface.

18. The computer-readable medium of claim 16, wherein the ranking is performed based on at least one of a determination of a degree of completion of the past and/or current matter associated with the component of the user interface.

19. The computer-readable medium of claim 15, wherein selecting at least one component further includes:
determining whether a phase, step and/or task associated with at least one of the plurality of components of the user interface of the received at least one past and/or current matter was performed manually or automatically; and
selecting at least one component based on the determination.

20. The computer-readable medium of claim 15, wherein selecting at least one component further includes:
determining a percentage of times a phase, step and/or task associated with at least one component was performed;
determining whether the percentage exceeds a predetermined threshold,
wherein at least one component is selected based on a determination that the percentage exceeds a predetermined threshold.

21. The computer-readable medium of claim 20, wherein the selected component is a task to be performed, the method further comprising:
determining, for the selected component, a custodian or a role of a custodian to be assigned to the component based on a custodian or a role of a custodian assigned to the component in a past and/or current matter; and
assigning the determined custodian or role of the custodian to the selected component.

22. A method for maintaining information for generating a recommendation, comprising:
storing attribute information associated with at least one past and/or current matter;
for each stored matter, storing a plurality of phases, each phase having at least one step, each step having at least one task, wherein each phase, step and task have information associated therewith;
receiving attribute information regarding a new matter;
generating a query based on the received attribute information;
accessing the at least one past and/or current matter and the associated attribute information and performing the query on the accessed at least one past and/or current matter;
receiving a result of the performed query, the result including at least one past and/or current matter and information associated therewith;
analyzing the received result; and
generating a recommendation in the new matter based on the analysis of the received result.

23. The method of claim 22, wherein the recommendation includes trend information associated with a likelihood of success.

24. The method of claim 22, further comprising:
storing at least one form associated with the at least one past and/or current matter;
accessing at least one form based on the analysis of the received result, wherein the recommendation includes the accessed at least one form.

25. The method of claim 24, further comprising:
accessing a plurality of forms;
ranking each of the forms based on attribute information of the past and/or current matter associated with the form; and
selecting at least one form based on the ranking, wherein the recommendation includes the selected form based on the ranking.

26. The method of claim 25, wherein the ranking is performed based on an award of the past and/or current matter associated with form.

27. The method of claim 25, wherein the ranking is performed based on a determination of a degree of completion of the past and/or current matter associated with the form.

28. The method of claim 22, wherein the attributes include at least one of a current matter type, issue, a potential damage award, a potential total cost, and information identifying a custodian and other matter-related information.

29. The method of claim 22, further comprising:
determining a workflow based on at least one of the plurality of phases, the at least one step, and the at least one task;
for each past and/or current matter in the search result, determining a percentage of completion of the determined workflow; and
comparing the percentage of completion of the determined workflow with at least one of the associated attributes of the past and/or current matter, wherein the recommendation is generated based on the comparison.

30. The method of claim 22, further comprising:
receiving for storage a new past and/or current matter, attribute information, and a plurality of phases, each phase having at least one step, each step having at least one task, wherein each phase, step and task have information associated therewith;
modifying at least one of the attribute information and the plurality of phases, the at least one step and the at least one task to remove confidential information; and
storing the new past and/or current matter and the modified attribute information, the plurality of phases, the at least one step and the at least one task.

31. The method of claim 22, further comprising:
storing at least one question associated with the at least one past and/or current matter;
accessing at least one question based on the analysis of the received result, wherein the recommendation includes the accessed at least one question.

32. The method of claim 31, further comprising:
accessing a plurality of questions;
ranking each of the questions based on attribute information of the past and/or current matter associated with the question; and
selecting at least one question based on the ranking, wherein the recommendation includes the selected question based on the ranking.

33. The method of claim 22, further comprising:
tagging documents received in the search results;
repeating performing the query; and
automatically tagging documents included in the results of the repeated performed query with the same tag in the first performed query.

34. An apparatus for maintaining information for generating a recommendation, comprising:
a memory storing a set of instructions;
a processor for executing the stored set of instructions to perform a method, the method comprising:
storing attribute information associated with at least one past and/or current matter;
for each stored matter, storing a plurality of phases, each phase having at least one step, each step having at least one task, wherein each phase, step and task have information associated therewith;
receiving attribute information regarding a new matter;
generating a query based on the received attribute information;
accessing the at least one past and/or current matter and the associated attribute information and performing the query on the accessed at least one past and/or current matter;
receiving a result of the performed query, the result including at least one past and/or current matter and information associated therewith;
analyzing the received result; and
generating a recommendation in the new matter based on the analysis of the received result.

35. The apparatus of claim 34, wherein the recommendation includes trend information associated with a likelihood of success.

36. The apparatus of claim 34, the method further comprising:
storing at least one form associated with the at least one past and/or current matter;
accessing at least one form based on the analysis of the received result, wherein the recommendation includes the accessed at least one form.

37. The apparatus of claim 36, the method further comprising:
accessing a plurality of forms;
ranking each of the forms based on attribute information of the past and/or current matter associated with the form; and
selecting at least one form based on the ranking, wherein the recommendation includes the selected form based on the ranking.

38. The apparatus of claim 37, wherein the ranking is performed based on an award of the past and/or current matter associated with form.

39. The apparatus of claim 37, wherein the ranking is performed based on a determination of a degree of completion of the past and/or current matter associated with the form.

40. The apparatus of claim 34, wherein the attributes include at least one of a current matter type, issue, a potential damage award, a potential total cost, and information identifying a custodian and other matter-related information.

41. The apparatus of claim 34, the method further comprising:
determining a workflow based on at least one of the plurality of phases, the at least one step, and the at least one task;
for each past and/or current matter in the search result, determining a percentage of completion of the determined workflow; and
comparing the percentage of completion of the determined workflow with at least one of the associated attributes of the past and/or current matter, wherein the recommendation is generated based on the comparison.

42. The apparatus of claim 34, further comprising:
receiving for storage a new past and/or current matter, attribute information, and a plurality of phases, each phase having at least one step, each step having at least one task, wherein each phase, step and task have information associated therewith;
modifying at least one of the attribute information and the plurality of phases, the at least one step and the at least one task to remove confidential information; and
storing the new past and/or current matter and the modified attribute information, the plurality of phases, the at least one step and the at least one task.

43. The apparatus of claim 34, further comprising:
storing at least one question associated with the at least one past and/or current matter;
accessing at least one question based on the analysis of the received result, wherein the recommendation includes the accessed at least one question.

44. The apparatus of claim 43, further comprising:
accessing a plurality of questions;
ranking each of the questions based on attribute information of the past and/or current matter associated with the question; and
selecting at least one question based on the ranking, wherein the recommendation includes the selected question based on the ranking.

45. The apparatus of claim 34, further comprising:
tagging documents received in the search results;
repeating performing the query; and
automatically tagging documents included in the results of the repeated performed query with the same tag in the first performed query.

46. A computer-readable medium, storing a set of instructions, executed by a processor, to perform a method for maintaining information for generating a recommendation, the method comprising:
storing attribute information associated with at least one past and/or current matter;
for each stored matter, storing a plurality of phases, each phase having at least one step, each step having at least one task, wherein each phase, step and task have information associated therewith;
receiving attribute information regarding a new matter;
generating a query based on the received attribute information;
accessing the at least one past and/or current matter and the associated attribute information and performing the query on the accessed at least one past and/or current matter;
receiving a result of the performed query, the result including at least one past and/or current matter and information associated therewith;
analyzing the received result; and
generating a recommendation in the new matter based on the analysis of the received result.

47. The computer-readable medium of claim 46, wherein the recommendation includes trend information associated with a likelihood of success.

48. The computer-readable medium of claim 46, the method further comprising:
storing at least one form associated with the at least one past and/or current matter;
accessing at least one form based on the analysis of the received result, wherein the recommendation includes the accessed at least one form.

49. The computer-readable medium of claim 48, the method further comprising:
accessing a plurality of forms;
ranking each of the forms based on attribute information of the past and/or current matter associated with the form; and
selecting at least one form based on the ranking, wherein the recommendation includes the selected form based on the ranking.

50. The computer-readable medium of claim 49, wherein the ranking is performed based on an award of the past and/or current matter associated with form.

51. The computer-readable medium of claim 49, wherein the ranking is performed based on a determination of a degree of completion of the past and/or current matter associated with the form.

52. The computer-readable medium of claim 46, wherein the attributes include at least one of a current matter type, issue, a potential damage award, a potential total cost, and information identifying a custodian and other matter-related information.

53. The computer-readable medium of claim 46, the method further comprising:
determining a workflow based on at least one of the plurality of phases, the at least one step, and the at least one task;
for each past and/or current matter in the search result, determining a percentage of completion of the determined workflow; and
comparing the percentage of completion of the determined workflow with at least one of the associated attributes of the past and/or current matter, wherein the recommendation is generated based on the comparison.

54. The computer-readable medium of claim 46, the method further comprising:
receiving for storage a new past and/or current matter, attribute information, and a plurality of phases, each phase having at least one step, each step having at least one task, wherein each phase, step and task have information associated therewith;
modifying at least one of the attribute information and the plurality of phases, the at least one step and the at least one task to remove confidential information; and
storing the new past and/or current matter and the modified attribute information, the plurality of phases, the at least one step and the at least one task.

55. The computer-readable medium of claim 46, the method further comprising:
storing at least one question associated with the at least one past and/or current matter;
accessing at least one question based on the analysis of the received result, wherein the recommendation includes the accessed at least one question.

56. The computer-readable medium of claim 55, the method further comprising:
accessing a plurality of questions;
ranking each of the questions based on attribute information of the past and/or current matter associated with the question; and
selecting at least one question based on the ranking, wherein the recommendation includes the selected question based on the ranking.

57. The computer-readable medium of claim 46, the method further comprising:
tagging documents received in the search results;
repeating performing the query; and
automatically tagging documents included in the results of the repeated performed query with the same tag in the first performed query.

58. A method for determining a cost for providing a recommendation, comprising:
initiating crawling at least one mass storage device;
receiving information associated with the crawled data;
estimating cost of analyzing collected information based on actual costs incurred in similar past and/or current matters;
comparing estimated cost of analyzing data with a predetermined threshold of cost to be spent on analyzing data; and
recommending proceeding with the matter if the compared cost does not exceed the predetermined threshold.

59. The method of claim 58, wherein at least two mass storage devices are crawled and wherein the estimated cost of analyzing the collected information is estimated separately for each mass storage device.

60. The method of claim 58, wherein the at least one mass storage device includes a plurality of documents and the crawled data includes information associated with each of the plurality of documents, the method further comprising:
analyzing information associated with each of the documents;
identifying characteristic information based on the analyzed information, the characteristic information including at least one of an original author of a document, contributors to contents of the document, other metadata information, and size of the document; and
providing chain of custody of each of the documents including the identified characteristic information.

61. The method of claim 60 wherein crawling includes:
identifying at least one custodian;
calculating a hash value of each document associated with the identified\ at least one custodian;
comparing the calculated hash value with at least one existing hash value; and
if the calculated hash value does not match the at least one existing hash value, the document is either preserved or collected.

62. The method of claim 61, wherein crawling is automatically performed periodically.

63. The method of claim 60, wherein the information associated with each of the documents is information included in a tag and the tag information is analyzed in order to identify characteristic information.

64. The method of claim 58, wherein the at least one mass storage device includes a plurality of documents and the crawled data includes information associated with each of the plurality of documents, the method further comprising:
tagging each of the plurality of documents based on the crawled data; and
assigning a task to a reviewer to review the tagged documents.

65. The method of claim 60, wherein the chain of custody includes information identifying the location of the document within the mass storage device.

66. An apparatus for determining a cost for providing a recommendation, comprising:
a memory storing a set of instructions; and
a processor configured to execute the stored set of instructions to perform a method comprising:
initiating crawling at least one mass storage device;
receiving information associated with the crawled data;
estimating cost of analyzing collected information based on actual costs incurred in similar past and/or current matters;
comparing estimated cost of analyzing data with a predetermined threshold of cost to be spent on analyzing data; and
recommending proceeding with the matter if the compared cost does not exceed the predetermined threshold.

67. The apparatus of claim 66, wherein at least two mass storage devices are crawled and wherein the estimated cost of analyzing the collected information is estimated separately for each mass storage device.

68. The apparatus of claim 66, wherein the at least one mass storage device includes a plurality of documents and the crawled data includes information associated with each of the plurality of documents, the method further comprising:
analyzing information associated with each of the documents;
identifying characteristic information based on the analyzed information, the characteristic information including at least one of an original author of a document, contributors to contents of the document, other metadata information, and size of the document; and
providing chain of custody of each of the documents including the identified characteristic information.

69. The apparatus of claim 68, wherein crawling includes:
identifying at least one custodian;
calculating a hash value of each document associated with the identified\ at least one custodian;
comparing the calculated hash value with at least one existing hash value; and
if the calculated hash value does not match the at least one existing hash value, the document is either preserved or collected.

70. The apparatus of claim 68, wherein crawling is automatically performed periodically.

71. The apparatus of claim 68, wherein the information associated with each of the documents is information included in a tag and the tag information is analyzed in order to identify characteristic information.

72. The apparatus of claim 66, wherein the at least one mass storage device includes a plurality of documents and the crawled data includes information associated with each of the plurality of documents, the method further comprising:
tagging each of the plurality of documents based on the crawled data; and
assigning a task to a reviewer to review the tagged documents.

73. The apparatus of claim 68, wherein the chain of custody includes information identifying the location of the document within the mass storage device.

74. A computer-readable medium, storing a set of instructions, executed by a processor, to perform a method for determining a cost for providing a recommendation, the method comprising:
initiating crawling at least one mass storage device;
receiving information associated with the crawled data;
estimating cost of analyzing collected information based on actual costs incurred in similar past and/or current matters;
comparing estimated cost of analyzing data with a predetermined threshold of cost to be spent on analyzing data; and
recommending proceeding with the matter if the compared cost does not exceed the predetermined threshold.

75. The computer-readable medium of claim 74, wherein at least two mass storage devices are crawled and wherein the estimated cost of analyzing the collected information is estimated separately for each mass storage device.

76. The computer-readable medium of claim 74, wherein the at least one mass storage device includes a plurality of documents and the crawled data includes information associated with each of the plurality of documents, the method further comprising:
analyzing information associated with each of the documents;
identifying characteristic information based on the analyzed information, the characteristic information including at least one of an original author of a document, contributors to contents of the document, other metadata information, and size of the document; and
providing chain of custody of each of the documents including the identified characteristic information.

77. The computer-readable medium of claim 76, wherein crawling includes:
identifying at least one custodian;
calculating a hash value of each document associated with the identified\ at least one custodian;
comparing the calculated hash value with at least one existing hash value; and
if the calculated hash value does not match the at least one existing hash value, the document is either preserved or collected.

78. The computer-readable medium of claim 77, wherein crawling is automatically performed periodically.

79. The computer-readable medium of claim 76, wherein the information associated with each of the documents is information included in a tag and the tag information is analyzed in order to identify characteristic information.

80. The computer-readable medium of claim 74, wherein the at least one mass storage device includes a plurality of documents and the crawled data includes information associated with each of the plurality of documents, the method further comprising:
tagging each of the plurality of documents based on the crawled data; and
assigning a task to a reviewer to review the tagged documents.

81. The computer-readable medium of claim 76, wherein the chain of custody includes information identifying the location of the document within the mass storage device.

82. The method of claim 1, wherein a plurality of components are selected and included in the dynamically generated user interface, the method further comprising:
selecting a subset of the components included in the dynamically generated user interface; and
dynamically generating a second user interface including the selected subset of the components.

83. The apparatus of claim 8, wherein a plurality of components are selected and included in the dynamically generated user interface, the method further comprising:
selecting a subset of the components included in the dynamically generated user interface; and
dynamically generating a second user interface including the selected subset of the components.

84. The computer-readable medium of claim 15, wherein a plurality of components are selected and included in the dynamically generated user interface, the method further comprising:
selecting a subset of the components included in the dynamically generated user interface; and
dynamically generating a second user interface including the selected subset of the components.
